(19) United States
(12) Patent Application Publication
(10) Pub. No.: US 2026/0320577 A1
(43) Pub. Date: Oct. 15, 2026

(54) SYSTEMS AND METHODS FOR REAL-TIME CHECK PROCESSING AND DEPOSITS AT POINT-OF-SALE SYSTEMS

(71) Applicant: JPMORGAN CHASE BANK, N.A., New York, NY (US)

(72) Inventors: Howard SPECTOR, Street, MD (US); Sridhar ARAVAMUDHAN, Middletown, DE (US); Louis CULOT, Brooklyn, NY (US); Edward J OLEBE, New Paltz, NY (US); Chris CONRAD, Philadelphia, PA (US); Emi ALEXANDER, New Canaan, CT (US)

(21) Appl. No.: 19/643,558

(22) Filed: Apr. 9, 2026

Related U.S. Application Data
(60) Provisional application No. 63/786,022, filed on Apr. 9, 2025.

(51) Int. Cl. G06Q 20/20; G06Q 20/10

(52) U.S. Cl. CPC G06Q 20/20; G06Q 20/108

(57) ABSTRACT

In some embodiments, the techniques described herein relate to a method including: receiving, by a point-of-sale application, an input of a credit card information, a user account, or a user’s identity; accessing, by the point-of-sale application and through an application programming interface (“API”) to a server hosting an account module executed by one or more processors, information regarding an account of the user; orchestrating, by an orchestrator module executed by one or more processors of the server, payment options for the consumer; and settling, by an account module executed by one or more processors of the server, a transaction based on a customer action.

### RELATED APPLICATIONS

This application claims priority to, and the benefit of, U.S. Provisional Patent Application Ser. No. 63/786,022, filed Apr. 9, 2025, the disclosure of which is hereby incorporated, by reference in its entirety. BACKGROUND OF THE INVENTION

### BACKGROUND OF THE INVENTION

### 1. Field

Embodiments relate to systems and methods for real-time check processing and deposits at point-of-sale systems.

### 2. Description of the Related Art

Conventional point-of-sale systems are generally configured to facilitate purchase transactions and, in some instances, limited cash withdrawal functionality during a purchase transaction. For example, a customer using a payment card to purchase goods or services may be permitted to receive cash back, with a corresponding debit being applied to an account associated with the card. These systems are typically oriented toward completing a retail sale and are not generally configured to support a broader range of account servicing functions at the point of sale.

In many environments, customers may wish to perform additional financial transactions while already present at a merchant location. By way of example, a customer may wish to deposit funds to an account associated with a payment card, make a payment toward a credit card balance or other line of credit, access information relating to an amount due, or otherwise transfer funds between a merchant location and one or more financial accounts. Conventional point-of-sale platforms often lack integrated functionality for initiating and completing such transactions in a coordinated manner with financial institution systems. As a result, customers may be required to use separate channels, such as automated teller machines, mobile applications, online banking platforms, or branch locations, which may increase transaction time and reduce convenience.

Existing merchant systems may also be limited in their ability to interface with financial networks or issuer systems in a manner that supports real-time movement of funds into or out of different account types, such as debit accounts, brokerage accounts, home equity line of credit accounts, or credit accounts. In some cases, merchant systems are not configured to present account-related options, such as a minimum payment amount, or to accept and process alternative forms of tender, such as cash or check, for application to a card-related account in real time. These limitations may prevent a customer from using funds available at the merchant location to satisfy an account obligation, increase available credit, or otherwise manage an account during a point-of-sale interaction.

Additional challenges may arise in circumstances where network connectivity is constrained or where merchants seek expanded financial functionality without substantial modification of existing infrastructure. Conventional approaches may not provide mechanisms for localized validation of account status or balances, near-real-time synchronization with remote financial systems, or flexible deployment models capable of supporting merchant locations under disrupted or bandwidth-limited conditions. Accordingly, improvements in point-of-sale systems and associated network architectures remain desirable to enable expanded transaction types, improved account interaction, and more efficient integration between merchants and financial account systems.

### SUMMARY

Exemplary embodiments provide systems and methods for point-of-sale systems. According to one embodiment, a method may include receiving, by a point-of-sale application, an input of a credit card information, a user account, or a user’s identity; accessing, by the point-of-sale application and through an application programming interface (“API”) to a server hosting an account module executed by one or more processors, information regarding an account of the user; orchestrating, by an orchestrator module executed by one or more processors of the server, payment options for the consumer; and settling, by an account module executed by one or more processors of the server, a transaction based on a customer action.

Example embodiments provide a computer-implemented method for processing a cash deposit transaction at a merchant point-of-sale location. According to one embodiment, a method may include receiving, by a point-of-sale device executing a point-of-sale application, account access data associated with a customer account and a deposit selection for depositing cash to a bank account associated with the customer account; receiving, by a merchant, a confirmation of a cash received from a customer at the merchant point-of-sale location for the deposit selection; transmitting, by the point-of-sale application and via an application programming interface to a remote server, the account access data and/or a deposit data identifying an amount of the cash; accessing, by the remote server, an account information corresponding to the bank account; generating, by the remote server, a deposit information for the bank account to be returned to the point-of-sale device; and applying, by an account module executed by one or more processors of the remote server, the amount of the cash as a deposit to the bank account based on the application programming interface.

The method may further comprise wherein the account access data comprises card information read from a payment card and an authentication input comprising at least one of a personal identification number, a passphrase, a push confirmation to a customer device, or a secondary tap of the customer device to unlock access to a plurality of linked accounts. The method may further comprise wherein the point-of-sale device identifies or confirms an identity of the customer using one or more of geofencing, Bluetooth Low Energy, Near Field Communication, and Wi-Fi and authenticates the customer using a personal identification number or passcode. The method may further comprise causing the deposit information for the bank account to be returned to the point-of-sale device, wherein causing the deposit information to include a balance of the bank account for presentation on a display of the point-of-sale device. The method may further comprise wherein the deposit selection identifies one linked account of the plurality of linked accounts as a destination for the amount of the cash. The method may further comprise wherein the point-of-sale device receives a customer selection redirecting the amount of the cash from the one linked account to another linked account of the plurality of linked accounts before the applying. The method may further comprise wherein the deposit data identifying the amount of the cash is passed as a parameter of an application programming interface call to the remote server. The method may further comprise wherein the applying the amount of the cash as the deposit to the bank account is performed in real time to update funds available to the customer account. The method may further comprise wherein an additional security process unlocks the deposit information before the deposit information is presented on the display of the point-of-sale device.

According to one embodiment, a computer-implemented method for maintaining locally usable customer account data at a merchant device may include storing, by a merchant device at a merchant location, encrypted account data for a local customer account; while the merchant device is disconnected from a remote network, summing one or more calculations of the encrypted account data at the merchant location to determine whether the local customer account has required funds without leaving a local network; allowing one or more transactions based on the summing of the one or more calculations; reconnecting the merchant device to the remote network; and receiving and updating, by the merchant device after reconnecting to the remote network, a batch of encrypted updates comprising an account status, the one or more transactions, and a balance for the local customer account.

Embodiments consistent with the present disclosure include a system including one or more processors and one or more storage devices storing instructions that when executed by one or more processors, cause the processor to perform one or more steps of the methods disclosed herein. Embodiments consistent with the present disclosure include a computer processing system, computer, or server, including: a memory configured to store instructions such as a non-transitory computer-readable storage medium; and a hardware processor operatively coupled to the memory for executing the instructions to perform one or more steps of the methods disclosed herein.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 is a block diagram of a system for point-of-sale systems, in accordance with embodiments.

FIG. 2 is a method for point-of-sale systems, in accordance with embodiments.

FIG. 3 is a block diagram of a computing device for implementing certain embodiments of the present disclosure.

### DETAILED DESCRIPTION

In embodiments, customers may not only get cash back from a point-of-sale device when conducting a transaction, but they may also deposit cash to an account associated with a debit card or make a payment to a credit card account. For example, a merchant may integrate with the network to move funds in/out of customers debit, brokerage, home equity line of credit (HELOC), and other accounts via an Application Programming Interface (API). Embodiments may return information to the customer at the point-of-sale device. For example, for a credit card, a balance, a minimum payment due, a payment due data, etc. may be presented on the point-of-sale device, and the customer may make a payment by providing cash to the merchant. The payment may be applied in real-time, thereby giving the customer additional open line of credit for purchases. Some embodiments may provide for batch updates to accommodate network outages where local customer accounts may be updated through encrypted communications with a payment network.

Conventional point-of-sale environments are generally configured to support purchase transactions and, in some cases, cash withdrawal functionality, but may not provide a practical mechanism for allowing a customer to deposit cash to an account, make a payment to a credit or loan account, or otherwise move funds among linked accounts from the merchant location in a manner that is integrated with account information and settlement processing. In addition, existing approaches may not adequately provide real-time visibility into account status at the point of sale, may not readily validate check information against account data during the transaction, and may be limited when network connectivity is unavailable or disrupted.

In some embodiments, these issues may be addressed by a point-of-sale architecture in which a point-of-sale application receives customer account access data and transaction input, communicates with a remote server through an application programming interface, and obtains account information that may be used to orchestrate available transaction options and settle a selected transaction. Such an arrangement may allow cash presented at a merchant location to be applied in real time as a deposit to a bank account or as a payment to a credit or loan account, may allow relevant account information to be presented to the customer for transaction selection, and may further support real-time check validation and processing. In some embodiments, customer identification and authentication may be used to unlock access to linked accounts, and encrypted account data maintained at a merchant device may be updated and used locally to support transaction decisions while limiting exposure of underlying account information and improving continuity during periods of reduced network availability.

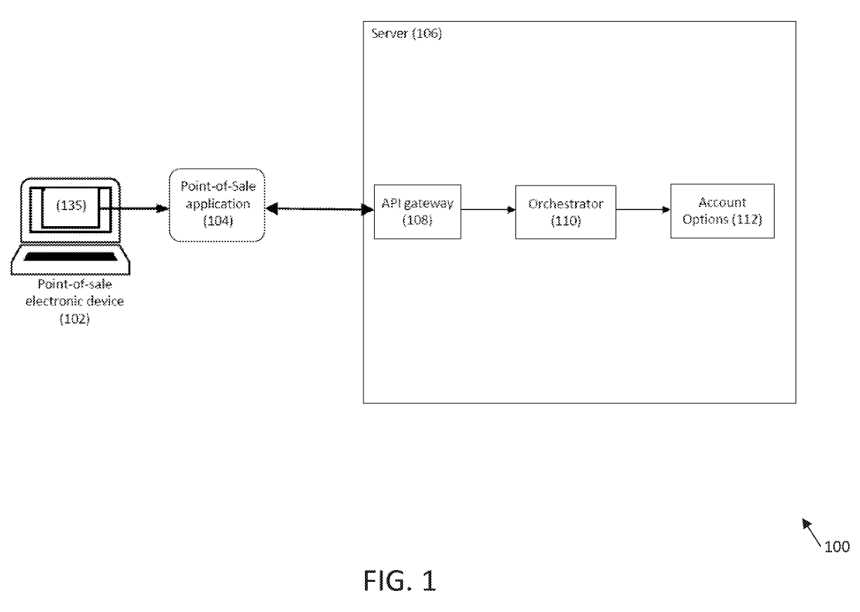

FIG. 1 is a block diagram of a system for point-of-sale systems, in accordance with embodiments. In the example of FIG. 1, a point-of-sale electronic device 102 executes a point-of-sale application 104 and one or more user interfaces 135. The point-of-sale electronic device 102 may be operated by a merchant and may include, or may be associated with, a cash handling arrangement for receiving physical tender, such as a cash drawer and/or a till used to receive cash from a customer as part of a deposit or payment transaction. The point-of-sale electronic device 102 further includes one or more communication interfaces for communicating with a server 106 over one or more networks.

In embodiments, the point-of-sale application 104 is configured to receive account access data associated with a customer account. The account access data may include credit card information, debit card information, a user account identifier, or a user identity. In some embodiments, the account access data is received by reading card information from a payment card and combining the card information with an authentication input, such as a personal identification number (PIN), a passphrase, a push confirmation to a customer device, or a secondary tap of the customer device. In such embodiments, the authentication input may unlock access to a plurality of linked accounts associated with the customer, thereby enabling selection among multiple destination accounts for a deposit or payment transaction.

In embodiments, the point-of-sale application 104 transmits information to the server 106 through an application programming interface (API). The information transmitted through the API may include the account access data, a transaction selection identifying a deposit, a payment, a check deposit, a cash-out transaction, or an account opening transaction, and one or more transaction parameters. In some embodiments, an amount of cash received at the merchant location is provided as deposit data identifying an amount of the cash, and the deposit data is passed as a parameter of an API call to the server 106. In some embodiments, the point-of-sale electronic device 102 transmits a merchant confirmation that the cash has been received, where the merchant confirmation is provided as a data element in the API call and is associated with the deposit data.

In embodiments, the server 106 executes an account module 108 to access account information corresponding to an account associated with the account access data. The account information may include a balance, a payment amount due, a minimum payment amount, and/or a payment due date, depending on an account type. In embodiments, the server 106 further executes an orchestrator module 110 that determines and/or orchestrates payment options, deposit options, and/or account servicing options presented to the customer at the merchant location through the user interfaces 135. For example, the orchestrator module 110 may determine which linked accounts are available as destinations for a cash deposit, may determine whether a credit account permits a minimum payment, and may determine whether a customer-selected redirection of funds from a first linked account to a second linked account is permissible before settlement.

In embodiments, deposit information and/or payment information is returned by the server 106 to the point-of-sale electronic device 102 as a response to an API call. The deposit information may include a current balance, an available balance, and/or one or more account servicing options associated with the customer account. In embodiments, the point-of-sale application 104 causes the deposit information and/or payment information to be presented on a display of the point-of-sale electronic device 102 to allow the customer to make an informed selection of an action at the merchant location. In some embodiments, an additional security process is executed before displaying sensitive deposit information and/or payment information, where the additional security process unlocks the data for presentation after successful completion of the additional security process.

In embodiments, the system supports identity confirmation and authentication using one or more proximity and/or location technologies. For example, geofencing, Bluetooth Low Energy, Near Field Communication, and/or Wi-Fi may be used to identify or confirm an identity of the customer and to associate the customer with the point-of-sale electronic device 102. In embodiments, the point-of-sale electronic device 102 and/or the server 106 uses a PIN, a passcode, a two-factor authentication mechanism, or similar authentication to authenticate the customer before enabling account servicing features. In some embodiments, the orchestrator module 110 accesses third-party applications or a verification module hosted by the server 106 to verify one or more of a user identity, card information, and account eligibility for a requested transaction.

In embodiments, the point-of-sale electronic device 102 is configured to accept physical tender and to complete a transaction that applies the physical tender to an account in real time. For example, when the customer selects a deposit to a bank account, the merchant receives cash from the customer, the point-of-sale application 104 transmits deposit data identifying the amount of the cash through the API to the server 106, and the account module 108 applies the amount of the cash as a deposit to the bank account. In embodiments involving payment to a credit card or other line of credit, the point-of-sale electronic device 102 presents at least one of a balance, a minimum payment amount, or a payment due date, the merchant receives cash from the customer corresponding to a customer-selected payment option, and the account module 108 settles the payment in real time such that available credit is updated for subsequent purchases.

In embodiments, the system supports real-time check processing at the point-of-sale electronic device 102. In such embodiments, the point-of-sale application 104 obtains check information and transmits the check information through the API to the server 106 for validation against a customer account. In some embodiments, check imaging is used in combination with a payment card to identify the customer account associated with the check, and the server 106 validates the check information based on at least a balance of the customer account, thereby enabling funds to be transferred to the merchant in real time.

In embodiments, the system supports operation during constrained network connectivity through localized processing of encrypted account data at the merchant location. For example, a merchant device at the merchant location, which may be the point-of-sale electronic device 102 or an associated device, stores encrypted account data for a local customer account and receives, in near real-time or in near real-time batches, encrypted updates about account status and balances. In some embodiments, the encrypted account data is processed using homographic encryption such that the data remains encrypted while being updated based on an incoming encrypted stream and while being used in one or more calculations to determine whether the local customer account has required funds without leaving a local network.

In embodiments, the merchant device uses a local network when disconnected from a remote network. In such embodiments, while the merchant device is disconnected, the merchant device uses the encrypted account data in one or more calculations to determine whether a transaction is permitted and to allow one or more transactions based on results of the one or more calculations. Upon reconnection to the remote network, the merchant device receives encrypted updates comprising at least an account status, the one or more transactions, and a balance for the local customer account, and the merchant device updates the encrypted account data for the local customer account based on the encrypted updates. In some embodiments, the merchant device comprises a cellular-enabled mobile device or a cellular-enabled tablet computer configured to reconnect the merchant location to the remote network after a network disruption, including after a natural disaster.

In embodiments, the system optionally supports issuance of a dynamic pre-paid debit card injected into a customer wallet for use in payments and for automated teller machine access when physical cash is not available at a merchant location or when an alternative disbursement mechanism is desired.

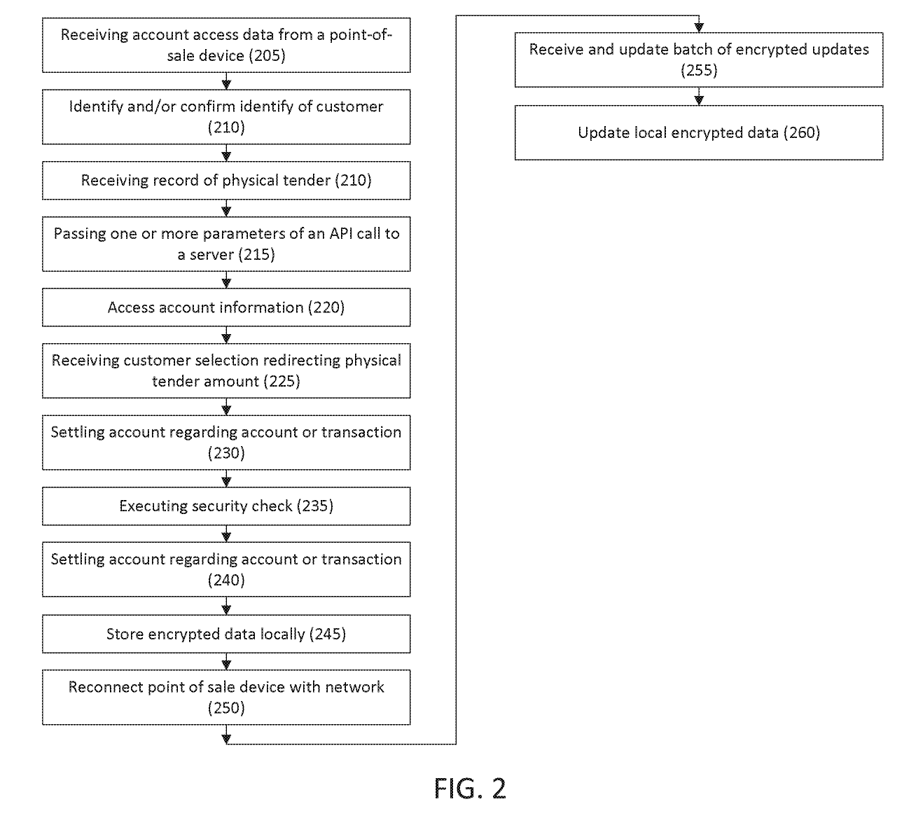

FIG. 2 is a method for point-of-sale systems, in accordance with embodiments.

Step 205 may include receiving, by the point-of-sale application 104 executed by the point-of-sale electronic device 102, account access data associated with a customer account and receiving a transaction selection. In embodiments, the transaction selection identifies a cash deposit to a bank account, a payment to a credit account, a cash-out transaction, a check processing transaction, and/or a loan-related transaction. In some embodiments, step 205 further includes receiving an authentication input comprising at least one of a PIN, a passphrase, a push confirmation to a customer device, or a secondary tap of the customer device to unlock access to a plurality of linked accounts.

Step 210 may include identifying and/or confirming an identity of the customer at the merchant location using geofencing, Bluetooth Low Energy, Near Field Communication, Wi-Fi, or a combination thereof, and authenticating the customer using a PIN, a passcode, and/or a two-factor authentication process. In embodiments, step 210 may be performed prior to enabling display of account information and prior to enabling the transaction selection to be executed.

Step 215 may include receiving, at the merchant point-of-sale location, physical tender corresponding to the transaction selection. In a deposit embodiment, the physical tender comprises cash received by the merchant from the customer for a deposit selection. In a payment embodiment, the physical tender comprises cash received by the merchant from the customer for a customer-selected payment option, including a minimum payment option when the account is a credit account or other line of credit. In embodiments, step 215 further includes generating deposit data or payment data identifying an amount of the physical tender and generating a merchant confirmation that the physical tender has been received.

Step 220 may include accessing, by the point-of-sale application 104 and through an API to the server 106, account information regarding an account associated with the account access data. In embodiments, the account information includes at least one of a balance, an available balance, a payment amount due, a minimum payment amount, and/or a payment due date. In some embodiments, the deposit data and/or merchant confirmation generated at step 215 is passed as one or more parameters of an API call to the server 106.

Step 225 may include orchestrating, by the orchestrator module 110 executed by one or more processors of the server 106, account servicing options for the customer based on the account information. In embodiments, step 225 includes determining, from among a plurality of linked accounts, one or more eligible destination accounts and presenting selectable options to deposit to or apply funds to a selected destination account. In some embodiments, step 225 further includes receiving a customer selection redirecting the amount of the physical tender from a first linked account to a second linked account before settlement.

Step 230 may include returning, by a server (e.g., the server 106), deposit information and/or payment information to the point-of-sale electronic device 102 in response to the API call, and causing the point-of-sale application 104 to present at least a portion of the deposit information and/or payment information via the user interfaces 135. In embodiments, step 230 includes presenting a balance and/or a minimum payment amount on a display of the point-of-sale electronic device 102.

Step 235 may include executing an additional security check before presenting sensitive data. In embodiments, step 235 includes unlocking the deposit information and/or payment information for display after successful completion of the additional security process. The security check may be one or more of inserting a personal identification number (PIN), a password, a liveliness check, a call and response, a text and response, or similar through the point of sale or through a user’s verified electronic device.

Step 240 may include settling, by the account module 108 executed by one or more processors of the server 106, a transaction based on the customer action and the amount of the physical tender. In a deposit embodiment, step 240 includes applying the amount of the cash as a deposit to a bank account in real time based on the API. In a payment embodiment, step 240 includes applying the amount of the cash to a credit account in real time such that available credit is updated for subsequent purchases.

Step 245 can include provisioning and storing, by a merchant device at the merchant location, encrypted account data for a local customer account so that the merchant device can continue to make account-based determinations when a remote network connection is unavailable or unreliable. In some embodiments, the merchant device can be a dedicated box installed at the merchant location and configured in a centralized or federated manner to match a merchant design. In some embodiments, the merchant device can be implemented by the point-of-sale electronic device 102 or by an associated mobile device, such as a cellular-enabled smart phone or a cellular-enabled tablet computer having storage capacity sufficient to hold the encrypted account data. The encrypted account data can correspond to one or more local customer accounts and can include encrypted information representing account status, account balance, and other account data used to determine whether the local customer account has required funds for a requested transaction. In some embodiments, the encrypted account data is received at the merchant location in real time, in near real-time, or in near real-time batches, and is stored locally so that the encrypted account data remains available within a local network of the merchant location.

In some embodiments, step 245 further includes maintaining the encrypted account data in a form that remains encrypted while the encrypted account data is updated and while the encrypted account data is used in calculations at the merchant location. For example, the merchant device can use homographic encryption so that incoming encrypted updates can be applied to locally stored encrypted account data without first decrypting the encrypted account data. In such embodiments, the merchant device can receive encrypted updates about account status and balances and can merge, append, or otherwise apply the encrypted updates to the locally stored encrypted account data while the data remains encrypted. The encrypted account data can thereby be retained within the merchant location and within the local network while still allowing the merchant device to perform local account determinations.

Step 250 can include operating the merchant device while the merchant device is disconnected from the remote network. In some embodiments, the merchant device remains in communication with the point-of-sale electronic device 102 and other local components through the local network even though the remote network is unavailable. During the disconnected condition, the merchant device uses the encrypted account data in one or more calculations at the merchant location to determine whether the local customer account has required funds without leaving the local network. The one or more calculations can include comparing encrypted account data associated with the local customer account to a requested transaction amount and, in some embodiments, summing one or more values represented by the encrypted account data to determine whether a threshold amount of funds is available. Based on the result of the one or more calculations, the merchant device can allow one or more transactions at the merchant location while the merchant device remains disconnected from the remote network. In this manner, the merchant location can continue operation during network interruption conditions while avoiding transmission of the account data outside the local network.

In some embodiments, the one or more transactions allowed during step 250 are retained by the merchant device as locally usable transaction information associated with the local customer account until connectivity is restored. For example, when the merchant device determines from the encrypted account data that the local customer account has required funds, the merchant device can allow a purchase transaction, a deposit-related transaction, or another account-servicing transaction and can retain information identifying the allowed transaction for later update after reconnection. In some embodiments, the merchant device continues to receive and use encrypted account data locally for multiple successive account determinations while disconnected so that a plurality of transactions can be evaluated and selectively allowed during the disconnected condition.

Step 255 may include reconnecting the merchant device to the remote network after the disconnected condition ends. In some embodiments, the reconnection is performed by a cellular communication interface of the merchant device, such as where the merchant device is a cellular-enabled smart phone or tablet computer configured to reconnect the merchant location to the remote network after a network disruption. Such a configuration may be used as an emergency deployment after a natural disaster and may also be used as a standard connection arrangement where cellular network coverage, including 5G coverage or other data transmission (e.g., satellite, 3G, 4G), is available. In other embodiments, the reconnection can be performed by another network interface of the merchant device while preserving the encrypted state of the locally stored encrypted account data.

Step 260 can include receiving, by the merchant device after reconnecting to the remote network, encrypted updates for the local customer account and updating the encrypted account data based on the encrypted updates. In some embodiments, the encrypted updates are received in near real time after reconnection. In some embodiments, the encrypted updates are received as a batch after reconnection. The encrypted updates may comprise account status, a balance for the local customer account, and information regarding the one or more transactions allowed while the merchant device was disconnected. The merchant device may apply the encrypted updates to the locally stored encrypted account data while the encrypted account data remains encrypted, thereby synchronizing the local customer account with the remote network without requiring the encrypted account data to leave the local network in decrypted form. After the updating, the merchant device can use the updated encrypted account data in a subsequent calculation at the merchant location to determine whether the local customer account has required funds for a later transaction. In some embodiments, the updated encrypted account data remains stored on the merchant device so that the merchant device can continue to receive subsequent encrypted updates in real time, in near real time, or in later batches as connectivity conditions change.

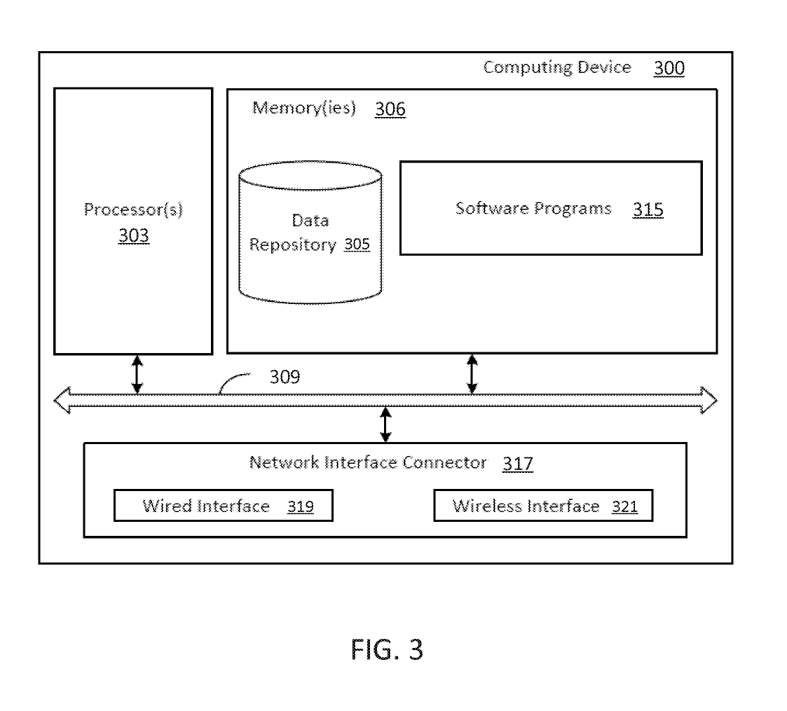

FIG. 3 is a block diagram of a computing device for implementing certain embodiments of the present disclosure.

FIG. 3 depicts exemplary computing device 300. Computing device 300 may represent hardware that executes the logic that drives the various system components described herein. For example, system components such as a user device, an interface, an event streaming platform, a matching algorithm, and various database/data store engines and servers, and other computer applications and logic may include, and/or execute on, components and configurations like, or similar to, computing device 300.

Computing device 300 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which may be executed by processor 303. Memory 306 may also include data repository 305, which may be nonvolatile memory for data persistence. The processor 303 and the memory 306 may be coupled by a bus 309. In some examples, the bus 309 may also be coupled to one or more network interface connectors 317, such as wired network interface 319, and/or wireless network interface 321. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A computer-implemented method for processing a cash deposit transaction at a merchant point-of-sale location, the method comprising:
receiving, by a point-of-sale device executing a point-of-sale application, account access data associated with a customer account and a deposit selection for depositing cash to a bank account associated with the customer account;
receiving, by a merchant, a confirmation of a cash received from a customer at the merchant point-of-sale location for the deposit selection;
transmitting, by the point-of-sale application and via an application programming interface to a remote server, the account access data and a deposit data identifying an amount of the cash;
accessing, by the remote server, an account information corresponding to the bank account;
generating, by the remote server, a deposit information for the bank account to be returned to the point-of-sale device; and
applying, by an account module executed by one or more processors of the remote server, the amount of the cash as a deposit to the bank account based on the application programming interface.

2. The method of claim 1, wherein:
the account access data comprises card information read from a payment card and an authentication input comprising at least one of a personal identification number, a passphrase, a push confirmation to a customer device, or a secondary tap of the customer device to unlock access to a plurality of linked accounts.

3. The method of claim 1, wherein:
the point-of-sale device identifies or confirms an identity of the customer using at least one of geofencing, Bluetooth Low Energy, Near Field Communication, or Wi-Fi and authenticates the customer using a personal identification number or passcode.

4. The method of claim 1, wherein:
causing the deposit information for the bank account to be returned to the point-of-sale device comprises causing the deposit information to include a balance of the bank account for presentation on a display of the point-of-sale device.

5. The method of claim 2, wherein:
the deposit selection identifies one linked account of the plurality of linked accounts as a destination for the amount of the cash.

6. The method of claim 5, wherein:
the point-of-sale device receives a customer selection redirecting the amount of the cash from the one linked account to another linked account of the plurality of linked accounts before the applying.

7. The method of claim 1, wherein:
the deposit data identifying the amount of the cash is passed as a parameter of an application programming interface call to the remote server.

8. The method of claim 1, wherein:
the applying the amount of the cash as the deposit to the bank account is performed in real time to update funds available to the customer account.

9. The method of claim 4, wherein:
an additional security process unlocks the deposit information before the deposit information is presented on the display of the point-of-sale device.

10. A system for processing a cash deposit transaction at a merchant point-of-sale location, the system comprising:
a point-of-sale device comprising a display and one or more processors configured to execute a point-of-sale application; and
a remote server in communication with the point-of-sale device via an application programming interface and comprising one or more processors configured to execute an account module;
wherein the point-of-sale device and the remote server are configured to:
receive account access data associated with a customer account and a deposit selection for depositing cash to a bank account associated with the customer account;
receive cash from a customer at the merchant point-of-sale location for the deposit selection;
transmit, via the application programming interface, the account access data and a deposit data identifying an amount of the cash to the remote server;
access an account information corresponding to the bank account;
generate a deposit information for the bank account to be returned to the point-of-sale device; and
apply, by the account module, the amount of the cash as a deposit to the bank account based on the application programming interface.

11. The system of claim 10, wherein:
the account access data comprises card information read from a payment card and an authentication input comprising at least one of a personal identification number, a passphrase, a push confirmation to a customer device, or a secondary tap of the customer device to unlock access to a plurality of linked accounts.

12. The system of claim 10, wherein:
the point-of-sale device is configured to identify or confirm an identity of the customer using at least one of geofencing, Bluetooth Low Energy, Near Field Communication, or Wi-Fi and authenticate the customer using a personal identification number or passcode.

13. The system of claim 10, wherein:
causing the deposit information for the bank account to be returned to the point-of-sale device comprises causing the deposit information to include a balance of the bank account for presentation on the display of the point-of-sale device.

14. The system of claim 11, wherein:
the deposit selection identifies one linked account of the plurality of linked accounts as a destination for the amount of the cash.

15. The system of claim 14, wherein:
the point-of-sale device is configured to receive a customer selection redirecting the amount of the cash from the one linked account to another linked account of the plurality of linked accounts before the account module applies the amount of the cash as the deposit.

16. The system of claim 10, wherein:
the deposit data identifying the amount of the cash is passed as a parameter of an application programming interface call to the remote server.

17. The system of claim 10, wherein:
the account module is configured to apply the amount of the cash as the deposit to the bank account in real time to update funds available to the customer account.

18. The system of claim 13, wherein:
an additional security process unlocks the deposit information before the deposit information is presented on the display of the point-of-sale device.

19. The system of claim 10, wherein:
the point-of-sale device comprises a cellular-enabled mobile device or tablet computer configured to reconnect the merchant point-of-sale location to a network after a network disruption.

20. A computer-implemented method for maintaining locally usable customer account data at a merchant device, the method comprising:
storing, by a merchant device at a merchant location, encrypted account data for a local customer account;
while the merchant device is disconnected from a remote network, summing one or more calculations of the encrypted account data at the merchant location to determine whether the local customer account has required funds without leaving a local network;
allowing one or more transactions based on the summing of the one or more calculations;
reconnecting the merchant device to the remote network; and
receiving and updating, by the merchant device after reconnecting to the remote network, a batch of encrypted updates comprising an account status, the one or more transactions, and a balance for the local customer account.
